(19) United States
(12) Patent Application Publication
(10) Pub. No.: US 2006/0024537 A1
(43) Pub. Date: Feb. 2, 2006

(54) Fuel cell system and method of controlling fuel cell

(75) Inventors: Goro Fujita, Ota-City (JP); Hiroki Kabumoto, Saitama-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/191,956

(22) Filed: Jul. 29, 2005

(30) Foreign Application Priority Data
Jul. 30, 2004 (JP) 2004-224288

(51) Int. Cl. H01M 8/00

(52) U.S. Cl. 429/12

(57) ABSTRACT

Cells constituting a fuel cell stack are measured for voltages with reference to a common ground. Here, voltmeters are used to measure voltages V1 to Vn across respective series of cells which increase in number in steps of two cells. Cell voltages Vc1 to Vcn each across two cells are calculated from the voltage measurements V1 to Vn, and then a standard deviation is calculated from the cell voltages Vc1 to Vcn. The standard deviation calculated thus can be used as an index of fuel concentration since it increases largely when the fuel concentration goes out of an allowable range.

### BACKGROUND OF THE INVENTION

1. Field of the Invention

The invention relates to a fuel cell. More particularly, the invention relates to control of a fuel cell in accordance with the state of fuel to be fed to the fuel cell.

2. Description of the Related Art

Fuel cells are devices for generating electric energy from fuel and an oxidant, and are capable of providing high generation efficiency. One of the chief features of the fuel cells is direct power generation without the process of thermal energy or kinetic energy as in conventional generation methods. High generation efficiency can thus be expected from fuel cells of even smaller scales. Besides, low emission of nitrogen compounds and the like, as well as low noise and low vibrations, yields improved environmental friendliness. As above, since the fuel cells can utilize the chemical energy of the fuel effectively and have the feature of environmental friendliness, they are expected as energy supply systems to bear the 21st century. In various applications ranging from large-scale power generation to small-scale power generation, such as space technologies, automobiles, and portable devices, the fuel cells are attracting attention as promising novel generation systems. Technological development toward practical use has thus been made in earnest.

Among various forms of fuel cells, a direct methanol fuel cell (DMFC) is recently gaining attention in particular. In the DMFC, methanol, the fuel, is fed directly to the anode without any modification so that electric power is generated through the electrochemical reaction between methanol and oxygen. As compared to hydrogen, methanol provides higher energy per unit volume, is well-suited to storage, and has low risk of explosion or the like. Applications such as the power supplies of automobiles and cellular phones are thus expected.

When the anode of the DMFC is fed with a methanol aqueous solution that has too high a concentration, degradation of the ion exchange membrane inside the DMFC is accelerated with a drop in reliability. There can also occur so-called cross leak, or the phenomenon that some of the methanol aqueous solution fed to the anode is not consumed for power generation but is transmitted through the ion exchange membrane to reach the cathode. On the other hand, if the concentration of the methanol aqueous solution is too low, the DMFC cannot provide sufficient output. For this reason, the methanol aqueous solution to be fed to the anode of the DMFC is preferably adjusted to 0.5 to 4 mol/L, or desirably 0.8 to 1.5 mol/L, in concentration. It is also known that this range of concentrations can be narrowed to operate the DMFC with stability.

Now, take the case of a system having a DMFC. For the sake of operating the DMFC for a long period and reducing the size and weight of the system as well, the system is typically provided with a tank for containing high-concentration methanol of 20 mol/L or above. In this method, the methanol must be thinned and adjusted in concentration before fed to the anode of the DMFC. Then, in order to adjust the concentration of the methanol aqueous solution to 0.5 to 1.5 mol/L inside the system, various types of methanol aqueous solution concentration sensors, including optical type, supersonic type, and specific-gravity type, have been used to measure the concentration of the methanol aqueous solution.

For example, Japanese Patent Laid-Open Publication No. 2004-095376 has disclosed the technique of installing a methanol sensor on a circulation path of the methanol aqueous solution at a location where a relatively smaller amount of carbon dioxide gas exists.

Nevertheless, if the concentration of the methanol aqueous solution to be fed to the anode is detected by using any methanol aqueous solution concentration sensor as heretofore, there can occur the following problems.

That is, when a methanol aqueous solution concentration sensor is installed inside the fuel cell system, system miniaturization becomes difficult. The operation of the methanol aqueous solution concentration sensor also consumes electric power, and thus requires extra power. Moreover, expenses necessary for the methanol aqueous solution concentration sensor push up the cost.

In addition, the conventional methanol aqueous solution concentration sensors are susceptible to external factors such as temperature changes and load fluctuations during the operation of the methanol fuel cell, and the occurrence of by-products. This means that the concentration measurements are not always precise.

### SUMMARY OF THE INVENTION

The present invention has been achieved in view of the foregoing problems. It is thus an object of the present invention to provide a technology for evaluating the concentration of the fuel to be fed to the fuel cell appropriately. Another object of the present invention is to provide control of a fuel cell system by using the foregoing technology.

A fuel cell system according to the present invention is a system including a fuel cell composed of a plurality of cells, the system comprising: a cell voltage detecting unit which detects voltages of the plurality of cells; and a cell voltage evaluating unit which evaluates variations in the detected voltages of the plurality of cells.

The cells each have a substantially constant generation efficiency as long as the fuel concentration falls within an appropriate range. The generation efficiencies decrease largely, however, as the fuel concentration goes out of the appropriate range. In general, the cells have individual differences in generation performance depending on the characteristics of the electrodes of the respective cells. Consequently, the cells show constant variations in voltage as long as the fuel concentration is in the appropriate range, whereas the variations grow larger as the fuel concentration goes out of the appropriate range. According to the invention described above, it is possible to detect the voltages of the plurality of cells and evaluate variations therein. The invention can thus be used to detect a change in the fuel concentration with reliability. Besides, the invention described above eliminates the need for a fuel sensor to be formed separately. This allows a reduction in space, power, and cost. In addition, since the voltages of the respective cells of the fuel cell are evaluated for variations directly, it is possible to evaluate the fuel concentration without being affected by external factors such as temperature changes, load fluctuations, and variations in the amount of by-products.

The foregoing configuration may comprise a notification unit which notifies that the concentration of the fuel goes out of an allowable range when the variations evaluated by the cell voltage evaluating unit exceed a reference value. Consequently, the user or the administrator of the system can precisely grasp that the concentration of the fuel fed to the fuel cell has gone out of the allowable range.

The foregoing configuration may also comprise: a fuel reservoir unit which reserves the fuel to be fed to the fuel cell; a fuel supply unit which supplies the fuel to the fuel reservoir unit; a fuel feed unit which feeds the fuel from the fuel reservoir unit to an anode of the fuel cell; an oxidant feed unit which feeds an oxidant to a cathode of the fuel cell; and a control unit which adjusts the supply of the fuel by the fuel supply unit. The control unit may supply the fuel to the fuel reservoir unit when the variations evaluated by the cell voltage evaluating unit exceed a reference value. Consequently, when the concentration of the fuel fed to the fuel cell drops, the fuel can be appropriately supplied to maintain the fuel cell in an appropriate state of generation. In the foregoing fuel cell system, the fuel may be a methanol aqueous solution.

A method of controlling a fuel cell according to the present invention is a method of controlling a fuel cell composed of a plurality of cells, the method comprising: detecting voltages of the plurality of cells; evaluating variations in the detected voltages of the plurality of cells; and supplying a fuel to be fed to the fuel cell when the evaluated variations exceed a reference value. Consequently, based on the variations in the voltages of the respective cells, it is possible to supply the fuel appropriately when the fuel concentration drops. In this method of controlling a fuel cell, the fuel may be a methanol aqueous solution.

Incidentally, any appropriate combinations of the foregoing components are also intended to fall within the scope of the invention covered by a patent to be claimed by this patent application.

### BRIEF DESCRIPTION OF THE DRAWINGS

FIG. 1 is a diagram showing the overall configuration of a fuel cell system according to an embodiment of the present invention;

FIG. 2 is a diagram showing the configuration of a fuel cell stack for use in the present embodiment;

FIG. 3 is a flowchart showing the operation of the fuel cell system according to the present embodiment;

FIG. 4 is a graph showing temporal changes of the cell voltages under a constant load;

FIG. 5 is a graph showing temporal changes of the ratios (%) of the differences between the respective cell voltages and the average of all the cell voltages with respect to the average of all the cell voltages, at each instant of time under the constant load;

FIG. 6 is a graph showing temporal changes of the standard deviation determined from the cell voltages under the constant load;

FIG. 7 is a graph showing temporal changes of the cell voltages under load fluctuations;

FIG. 8 is an enlarged graph showing the elliptic area of FIG. 7;

FIG. 9 is a graph showing temporal changes of variations determined from the cell voltages under load fluctuations; and

FIG. 10 is a graph showing temporal changes of the standard deviation determined from the cell voltages under load fluctuations.

### DETAILED DESCRIPTION OF THE INVENTION

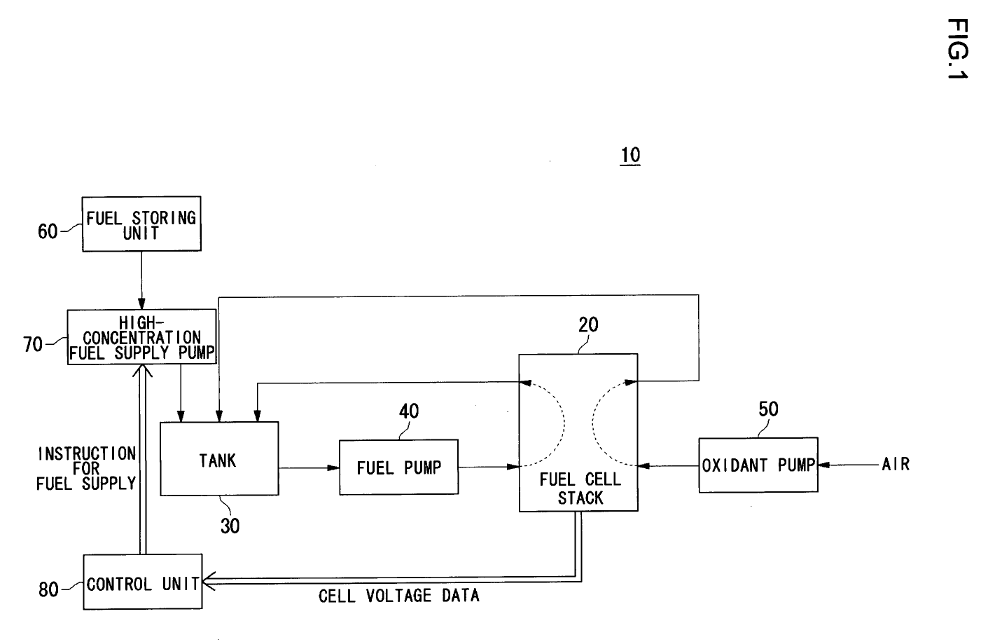

Hereinafter, an embodiment of the present invention will be described with reference to the drawings. FIG. 1 shows the overall configuration of a fuel cell system 10 according to the embodiment of the present invention. The fuel cell system 10 comprises a fuel cell stack 20, a tank 30, a fuel pump 40, an oxidant pump 50, a fuel storing unit 60, a high-concentration fuel supply pump 70, and a control unit 80.

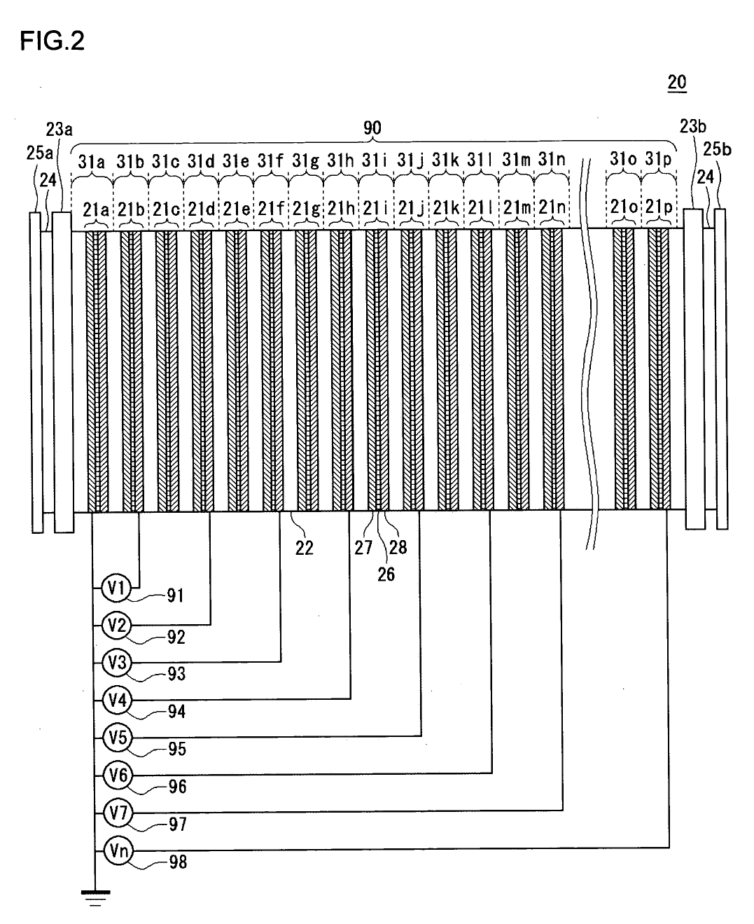

The fuel cell stack 20 generates electric power through electrochemical reaction by using a methanol solution and air. FIG. 2 shows the configuration of the fuel cell stack 20 for use in the present embodiment. The fuel cell stack 20 comprises a laminate 90, a current collector 23a for a negative pole, a current collector 23b for a positive pole, and end plates 25a and 25b. The laminate 90 is formed by laminating a plurality of membrane electrode assemblies 21 and bipolar plates 22. The current collectors 23a and 23b are arranged across the laminate 90. The end plates 25a and 25b are attached to the collectors 23a and 23b via insulators 24 interposed therebetween, respectively. The laminate 90 is fastened by the end plates 25a and 25b.

The fuel cell stack 20 of the present embodiment has m membrane electrode assemblies 21 in lamination. In FIG. 2, for the sake of distinction among the individual membrane electrode assemblies, alphabetical letters are added to the reference numerals 21 like the membrane electrode assemblies 21a to 21p. Each of the membrane electrode assemblies 21 includes a polymer ion exchange membrane 26, an anode 27 in contact with one side of the polymer ion exchange membrane 26, and a cathode 28 in contact with the other side of the polymer ion exchange membrane 26. The anode 27 and the cathode 28 contain a catalyst layer each. The anode 27 uses a platinum catalyst or a platinum-ruthenium alloy catalyst, and the cathode 28 a platinum catalyst.

Cells 31a to 31p include the respective corresponding membrane electrode assemblies 21a to 21p, fuel channels, and oxidant channels, and function as a single unit of fuel cell each.

The anode-27 side of each of the bipolar plates 22 is provided with a fuel channel for the fuel to circulate through. The cathode-28 side of each bipolar plate 22 is provided with an oxidant channel for the oxidant to circulate through. In the present embodiment, a methanol aqueous solution is used as the fuel, and air as the oxidant. Incidentally, a fuel plate having a fuel channel, an oxidant plate having an oxidant channel, and a separator interposed between the fuel plate and the oxidant plate may be used instead of the bipolar plate.

The fuel cell stack 20 of the present embodiment further comprises voltmeters 91 to 98. The voltmeters 91 to 98 measure a serial voltage V1 across the cells 31a and 31b, a serial voltage V2 across the cells 31a to 31d, a serial voltage V3 across the cells 31a to 31f, a serial voltage V4 across the cells 31a to 31h, a serial voltage V5 across the cells 31a to 31j, a serial voltage V6 across the cells 31a to 31l, a serial voltage V7 across the cells 31a to 31n, and a serial voltage Vn across the cells 31a to 31p, respectively, with reference to a common ground. The voltage values measured by the respective voltmeters 91 to 98 are transmitted to the control unit 80 to be described later. As above, since the voltages of the cells 31 are measured by using the common ground, it is possible to reduce the number of channels required of an AD converter that is necessary for the arithmetic processing in the control unit 80.

Returning to FIG. 1, the tank 30 reserves the methanol aqueous solution to be fed to the fuel cell stack 20. The methanol aqueous solution reserved in the tank 30 is diluted into 0.5 to 1.5 mol/L before the fuel pump 40 feeds it to each of the anodes 27 in the fuel cell stack 20. After the reaction in the fuel cell stack 20, unreacted fuel is recovered into the tank 30. In this way, the methanol aqueous solution fed to the fuel cell stack 20 circulates through the circulation system including the fuel cell stack 20 and the tank 30. Meanwhile, the oxidant pump 50 introduces air from exterior, and feeds it to each of the cathodes 28 in the fuel cell stack 20. Products of the methanol-air reaction, such as water, are recovered into the tank 30.

The fuel storing unit 60 stores a high-concentration methanol aqueous solution having a concentration higher than that of the methanol aqueous solution reserved in the tank. For example, if the methanol aqueous solution in the tank 30 has a concentration of 8 mol/L, the high-concentration methanol aqueous solution in the fuel storing unit 60 may have a concentration of 22 mol/L. The high-concentration fuel supply pump 70 supplies a predetermined amount of high-concentration methanol aqueous solution from the fuel storing unit 60 to the tank 30 under the instruction of the control unit 80 to be described later.

The control unit 80 calculates the voltages of the respective cells 31 based on the voltage values V1 to Vn transmitted from the voltmeters 91 to 98, and evaluates the voltages of the respective cells 31 for variations. The variations in the voltages of the cells obtained by the control unit 80 are preferably in terms of a standard deviation determined from the voltages of the respective cells. Moreover, based on the evaluations on the variations in the voltages of the cells 31, the control unit 80 controls the operation of the high-concentration fuel supply pump 70 to adjust the amount of the high-concentration methanol aqueous solution to be fed to the tank 30.

In the present embodiment, the voltages of the respective cells 31 are calculated by the following formulas:
the serial voltage Vc1 across the cells 31a and 31b: V1
the serial voltage Vc2 across the cells 31c and 31d: V2−V1
the serial voltage Vc3 across the cells 31e and 31f: V3−V2
the serial voltage Vc4 across the cells 31g and 31h: V4−V3
the serial voltage Vc5 across the cells 31i and 31j: V5−V4
the serial voltage Vc6 across the cells 31k and 31l: V6−V5
the serial voltage Vc7 across the cells 31m and 31n: V7−V6
the serial voltage Vcn across the cells 31o and 31p: Vn−V(n−1)

In the present embodiment, n voltmeters are used to monitor the voltages of all the m cells 31. In the present embodiment, n=m/2. Voltmeters may also be provided for the respective cells 31 and detect the voltages of the cells 31, respectively, and this mode may be applied to the present invention. Nevertheless, when the voltages of a plurality of cells 31 are collectively detected by a single voltmeter as in the present embodiment, the number of input/output terminals for the control unit 80 can be reduced to lower the parts count for cost saving. Moreover, the amount of data can be reduced to ease the burden of the arithmetic processing in the control unit 80.

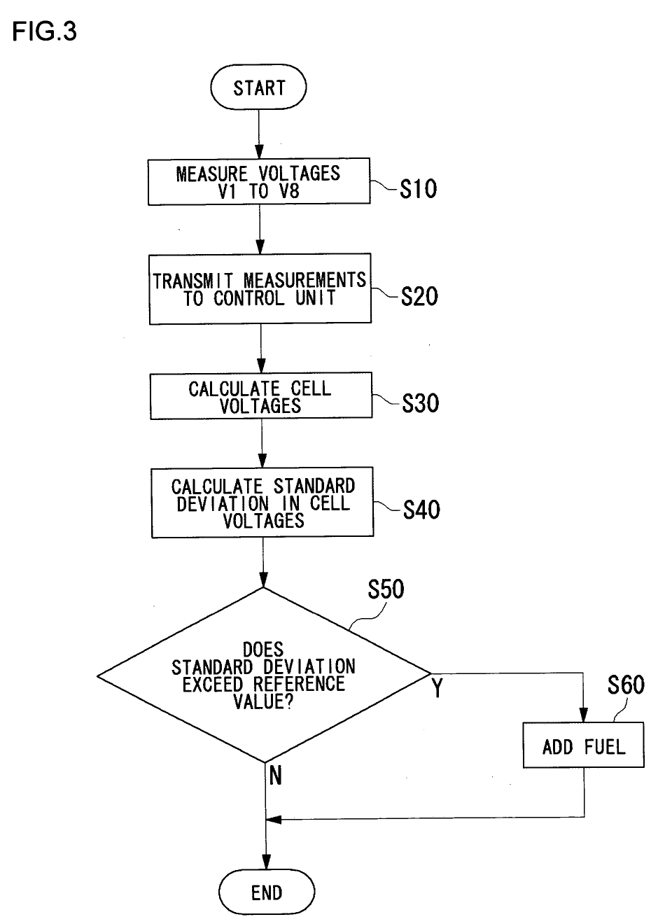

FIG. 3 is a flowchart showing the operation of managing the methanol aqueous solution in the fuel cell system 10. Initially, the voltmeters 91 to 98 measure the voltages V1 to Vn, respectively (S10). The voltage measurements V1 to Vn are individually transmitted to the control unit 80 (S20). The control unit 80 calculates the cell voltages Vc1 to Vcn from the voltages V1 to Vn (S30). The control unit 80 also calculates a standard deviation in the cell voltages Vc1 to Vcn calculated (S40). The control unit 80 determines whether or not the calculated standard deviation exceeds a predetermined reference value (S50). If the calculated standard deviation does not exceed the predetermined reference value, this processing is terminated. On the other hand, if the calculated standard deviation exceeds the predetermined reference value, the control unit 80 supplies the high-concentration methanol aqueous solution to the tank 30 by using the high-concentration fuel supply pump 70 (S60). As above, when variations in the plurality of cell voltages are detected and the fuel is supplied depending on the variations in the plurality of cell voltages, it is possible to maintain the states of generation of the fuel cells appropriately.

(Examples of Changes in Cell Voltage)

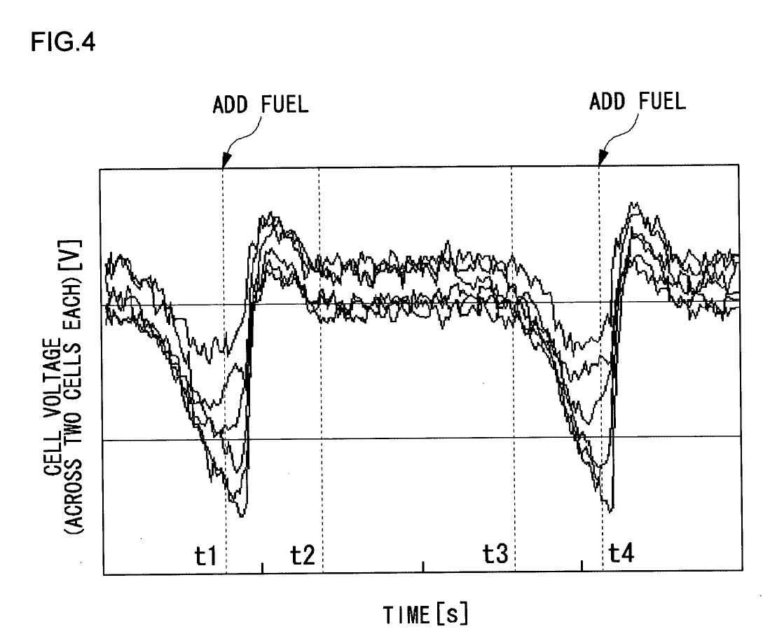

FIG. 4 is a graph showing temporal changes of the cell voltages under a constant load. As can be seen from FIG. 4, the individual cell voltages stay at near constant values between time t2 and time t3 before they start to fall gradually along with a drop in the concentration of the methanol aqueous solution. Immediately after time t3, the cell voltages decrease uniformly. Beyond some point in time, the cell voltages start to grow in variations.

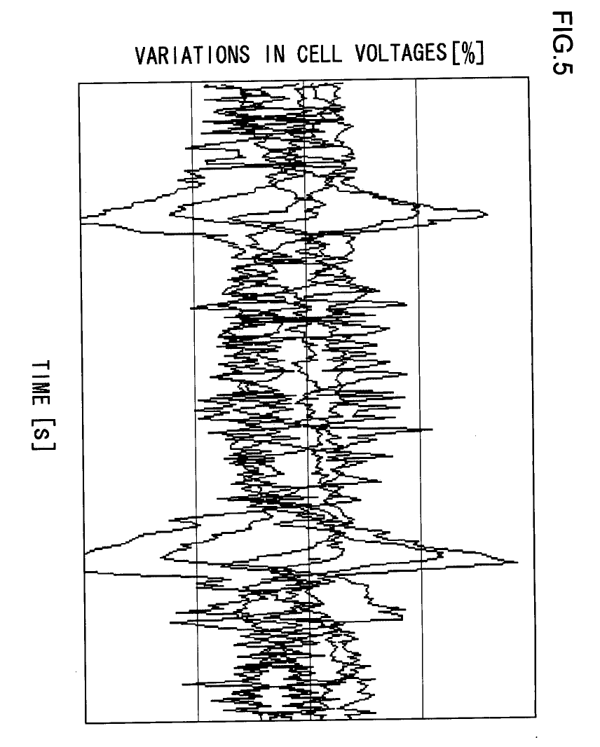

FIG. 5 is a graph showing temporal changes of the ratios (%) of the differences between the respective cell voltages and the average of all the cell voltages with respect to the average of all the cell voltages, at each instant of time under the constant load. From FIG. 5, it can be seen how variations in the voltages of the cells increase with a lapse of time, i.e., with a drop in the concentration of the methanol aqueous solution.

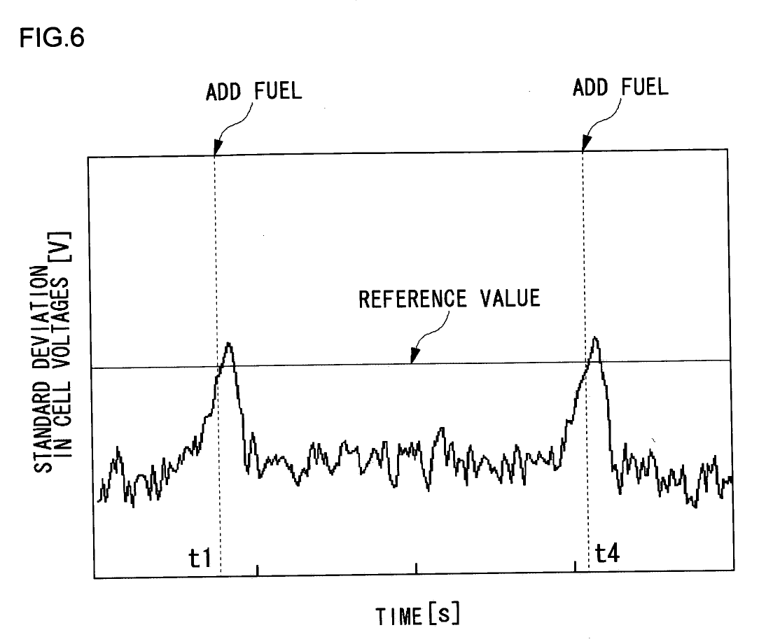

FIG. 6 is a graph showing temporal changes of the standard deviation determined from the cell voltages under the constant load. The fuel is added at times t1 and t4 when the value of the standard deviation exceeds the reference value. The standard deviation increases until the addition of the fuel takes effect. Then, the standard deviation decreases as the concentration of the methanol aqueous solution in the fuel cell stack 20 increases due to the addition of the fuel.

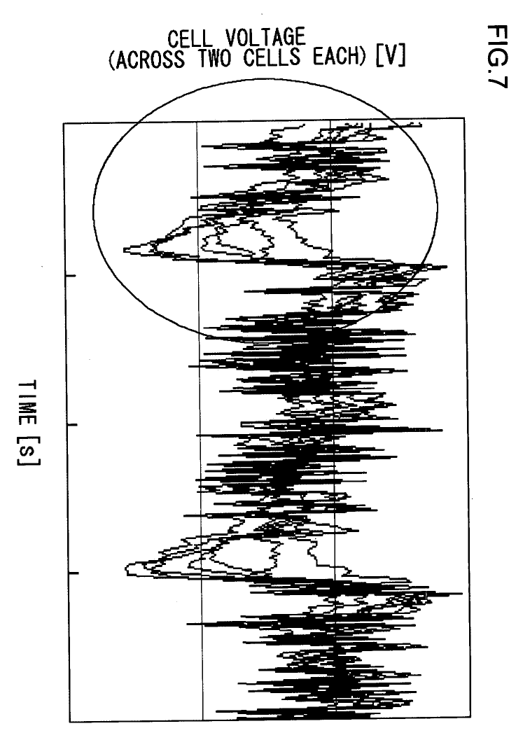

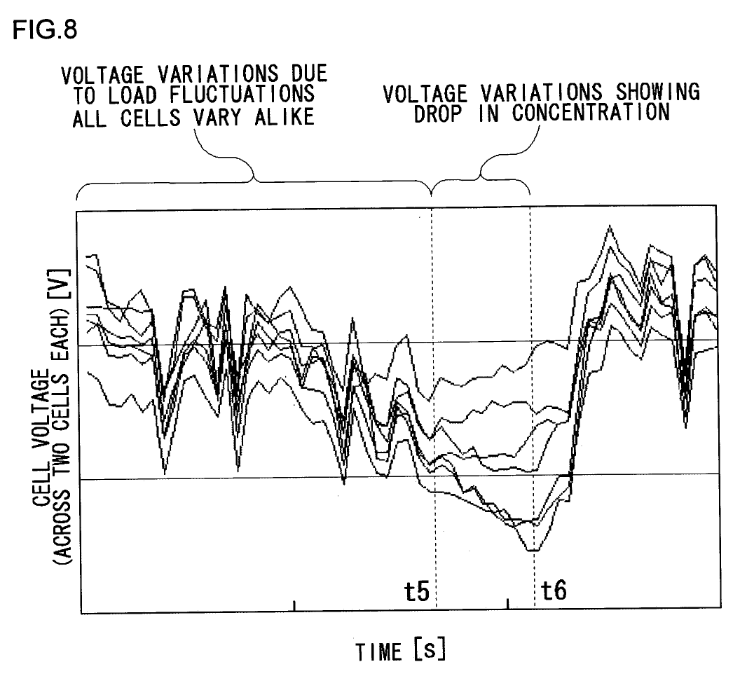

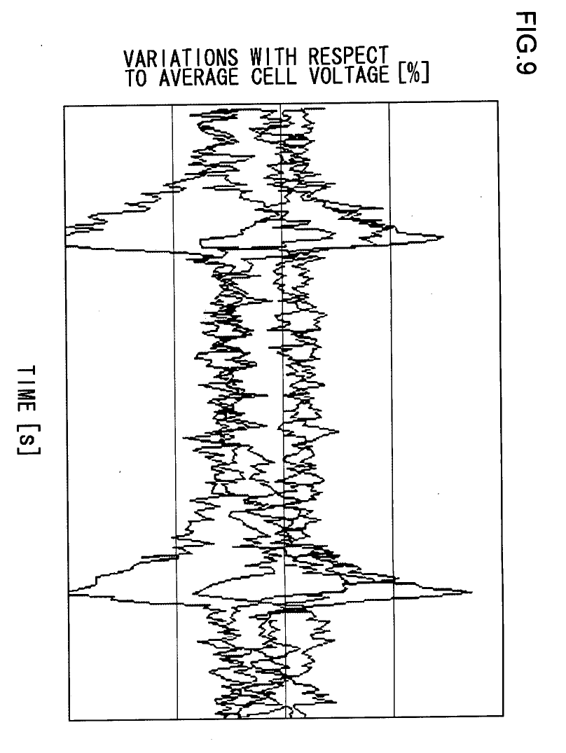

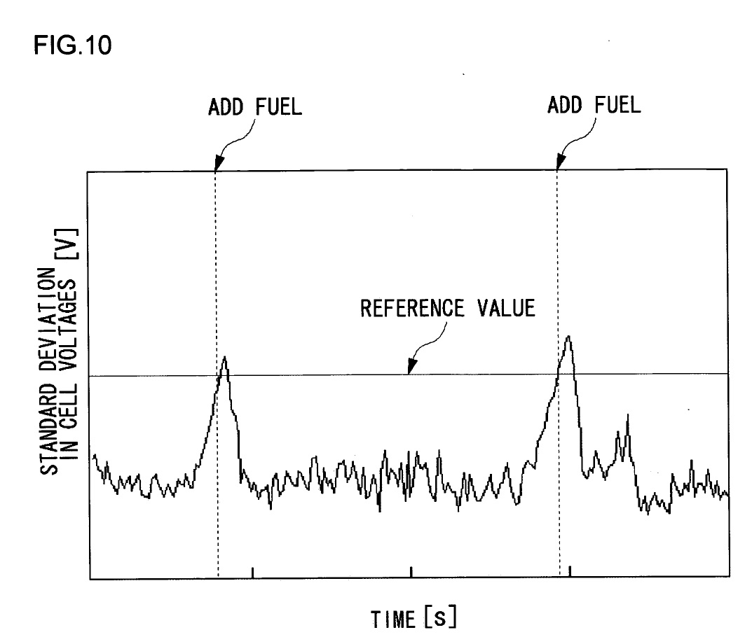

FIG. 7 is a graph showing temporal changes of the cell voltages under load fluctuations. For the sake of providing the load fluctuations, a notebook PC is connected across the current collectors 23a and 23b of the fuel cell stack 20, and this notebook PC is operated in this state. From a comparison between FIGS. 7 and 4, it can be seen that the cell voltages vary more sharply when under load fluctuations. FIG. 8 is a graph in which the ellipsed area of FIG. 7 is shown enlarged so that variations in the cell voltages under load fluctuations can be seen easily. Even under load fluctuations, as shown between time 0 and time t5, the voltages of the respective cells vary all alike. Voltage variations ascribable to a drop in the concentration of the methanol aqueous solution are observed after time t5. FIG. 9 is a graph showing temporal changes of the variations determined from the cell voltages under load fluctuations. FIG. 10 is a graph showing temporal changes of the standard deviation determined from the cell voltages under load fluctuations. As can be seen from FIGS. 9 and 10, the variations in the cell voltages under load fluctuations and the standard deviation determined from the cell voltages behave the same as with a constant load. Thus, even under load fluctuations, the concentration of the methanol aqueous solution can be evaluated appropriately by using the standard deviation determined from the cell voltages.

(Setting of Reference Value)

The reference value, or the criterion for fuel addition, may be a fixed value which is set in advance or a variable value which varies with a lapse of time.

If the reference value is fixed, the control unit 80 sets the reference value as a fixed value, for example, in a test process before the shipment of the fuel cell system. The reference value may be set to a times (a is a number greater than 1; preferably, a=1.5 to 3) the standard deviation σ0 that is determined from the cell voltages for situations with an appropriate concentration of methanol aqueous solution before the shipment of the fuel cell system. As a result, it is possible to set appropriate reference values in accordance with individual differences of respective fuel cell systems, thereby making it possible to perform fuel addition at appropriate timing.

If the reference value is variable, the control unit 80 sets the foregoing parameter a as a fixed value, for example, in a test process before the shipment of the fuel cell system. In this case, the control unit 80 determines the individual cell voltages from the voltage values V1 to Vn in the steady state between t2 and t3 of FIG. 4, and then calculates a standard deviation σ1 from the cell voltages. The control unit 80 sets a×σ1 as the reference value for the next fuel addition. In this way, by rendering the reference value variable and modifying it based on the standard deviation of the cell voltages in the steady state, the reference value is reset in accordance with temporal changes of the cell characteristics. It is therefore possible to add the fuel appropriately according to changes in the cell characteristics.

(Evaluation on Variations of ell Voltages)

In the foregoing embodiment, variations of the cell voltages are evaluated based on the standard deviation therein. However, other evaluation methods may also be applied to the present invention.

For example, by using the graph of FIG. 5, the criterion for fuel addition may be set at the point where the number of cells having cell-voltage variations (%) higher than a predetermined value, e.g., 5% exceeds a predetermined number, e.g., half the total number of cells.

(Method of Measuring Cell Voltages)

The method of measuring cell voltages need not always take the form of detecting the voltages in units of two cells as in the foregoing embodiment. For example, voltmeters may be provided for the respective cells so that the voltages of the respective cells can be grasped more precisely.

Suppose now that the voltages are detected in units of two or more cells and there occurs any remainder, like when an odd number of cells in total are subjected to the two-cell voltage measurement and thus a single cell is left behind. In such cases, the following processing is suitably conducted.

[When a Fuel Cell Stack Having an Odd Number of Cells in Total is Measured for Voltages in Units of Two Cells]

From the voltage values Vi of respective pairs of cells (i=1 to j), Vi/2 are calculated to determine voltages Vi per cell (i=1 to j). Voltage variations are evaluated by using the voltages Vi (i=1 to j) and a voltage Vh of the remaining cell. In this way, the fuel state can be evaluated according to the states of the voltages of all the cells while the number of detection points can be reduced to decrease the number of input channels necessary for the arithmetic processing in the control unit 80. This makes it possible to simplify the system structure and reduce the cost as well.

(Notification of Low Fuel)

In addition to or instead of the addition of the fuel, the control unit 80 may display text or an image on a display unit to notify of the occurrence of low fuel when variations in the cell voltages exceed the reference value as described above. This allows the user or administrator of the fuel cell system to grasp the occurrence of low fuel easily.

The present invention is not limited to the foreign embodiments, and various modifications including design changes may be made thereto based on the knowledge of those who skilled in the art. All such modified embodiments are also intended to fall within the scope of the present invention.

For example, the high-concentration fuel supply pump 70 may feed a certain amount of high-concentration methanol aqueous solution from the fuel storing unit 60 to the tank 30 intermittently. Here, the control unit 80 may monitor variations in the cell voltages and may add the fuel when the concentration of the methanol aqueous solution fed to the fuel cell stack 20 suddenly drops for some reason.

The foregoing embodiment has dealt with the case where the methanol aqueous solution is used as the fuel. According to the concept of the fuel cell system described above, however, the fuel is not limited to the methanol aqueous solution but may be hydrogen.

Moreover, the foregoing embodiment has dealt with the case where V1 to Vn are measured with reference to the common ground before the cell voltages Vc1 to Vcn are calculated by arithmetic operations. Instead, voltmeters capable of measuring the cell voltages Vc1 to Vcn directly may be installed individually.

What is claimed is:

1. A fuel cell system including a fuel cell composed of a plurality of cells, the system comprising:
a cell voltage detecting unit which detects voltages of the plurality of cells; and
a cell voltage evaluating unit which evaluates variations in the detected voltages of the plurality of cells.

2. The fuel cell system according to claim 1, comprising a notification unit which notifies that the concentration of the fuel goes out of an allowable range when the variations evaluated by the cell voltage evaluating unit exceed a reference value.

3. The fuel cell system according to claim 1, further comprising:
a fuel reservoir unit which reserves the fuel to be fed to the fuel cell;
a fuel supply unit which supplies the fuel to the fuel reservoir unit;
a fuel feed unit which feeds the fuel from the fuel reservoir unit to an anode of the fuel cell;
an oxidant feed unit which feeds an oxidant to a cathode of the fuel cell; and
a control unit which adjusts the supply of the fuel by the fuel supply unit, and wherein
the control unit supplies the fuel to the fuel reservoir unit when the variations evaluated by the cell voltage evaluating unit exceed a reference value.

4. The fuel cell system according to claim 2, further comprising:
a fuel reservoir unit which reserves the fuel to be fed to the fuel cell;
a fuel supply unit which supplies the fuel to the fuel reservoir unit;
a fuel feed unit which feeds the fuel from the fuel reservoir unit to an anode of the fuel cell;
an oxidant feed unit which feeds an oxidant to a cathode of the fuel cell; and
a control unit which adjusts the supply of the fuel by the fuel supply unit, and wherein
the control unit supplies the fuel to the fuel reservoir unit when the variations evaluated by the cell voltage evaluating unit exceed a reference value.

5. The fuel cell system according to claim 1, wherein the fuel is a methanol aqueous solution.

6. The fuel cell system according to claim 2, wherein the fuel is a methanol aqueous solution.

7. The fuel cell system according to claim 3, wherein the fuel is a methanol aqueous solution.

8. The fuel cell system according to claim 4, wherein the fuel is a methanol aqueous solution.

9. A method of controlling a fuel cell composed of a plurality of cells, the method comprising:
detecting voltages of the plurality of cells;
evaluating variations in the detected voltages of the plurality of cells; and
supplying a fuel to be fed to the fuel cell when the evaluated variations exceed a reference value.

10. The method of controlling a fuel cell according to claim 9, wherein the fuel is a methanol aqueous solution.
